(19) United States
(12) Patent Application Publication
(10) Pub. No.: US 2021/0039195 A1
(43) Pub. Date: Feb. 11, 2021

(54) Method And Device For Laser Welding A First Component To A Second Component

(71) Applicant: COMMISSARIAT A L'ENERGIE ATOMIQUE ET AUX ENERGIES ALTERNATIVES, Paris (FR)

(72) Inventors: Pierre Jost, Grenoble (FR); Michel Bel, Grenoble (FR); Ivo Canale, Grenoble (FR); Olivier Masson, Grenoble (FR); Guillaume Claude, Grenoble (FR)

(73) Assignee: COMMISSARIAT A L'ENERGIE ATOMIQUE ET AUX ENERGIES ALTERNATIVES, Paris (FR)

(21) Appl. No.: 17/044,492

(22) PCT Filed: Apr. 4, 2019
(86) PCT No.: PCT/FR2019/050794

§ 371 Date: Oct. 1, 2020

(30) Foreign Application Priority Data
Apr. 4, 2018 (FR) 1852908

(51) Int. Cl. B23K 26/04; H01M 10/04; B23K 26/082; B23K 26/0622; B23K 26/06

(52) U.S. Cl. CPC B23K 26/048; H01M 10/04; B23K 26/0661; B23K 26/0622; B23K 26/082

(57) ABSTRACT

The invention relates to a method for laser welding a first component to a second component, comprising:
placing the first component on the second component;
applying a welding mask comprising a flat contact surface to the first component to press the first component onto the second component, the welding mask comprising a through-passage for a laser beam, defining a welding area on the first component, the contact surface at least partially surrounding said passage; emitting a laser beam by a head into the passage of the welding mask, to form a weld bead joining the first component to the second component in the welding area; wherein the welding mask is rigid and rigidly joined to the laser head and the focal length of the laser is constant, the constant focal length being ensured by the rigid mask.

### FIELD OF THE INVENTION

The present invention relates to a method and a device for laser welding a first component onto a second component, in particular in the case where the first component is a metal current collector and the second metal component is a pole of a metal-ion electrochemical accumulator, and application of said method to the assembly of a battery.

### PRIOR ART

A battery is carried out by the assembly of a plurality of accumulators solidly attached to one another by a flange inside of which they are glued.

Said accumulators are electrically connected by current collectors that generally have the form of metal foils.

Each accumulator has a general cylindrical or prismatic shape, comprising a positive pole and a negative pole. These positive and negative poles can be on two opposite faces or on the same face of the accumulator.

Due to the manufacturing tolerances of the accumulators, as well as variations in height resulting from their positioning in the flange, the poles to be electrically connected are not necessarily in the same plane. Consequently, during the positioning of the current collector facing the poles, there can be a space between the current collector and the pole on which the current collector has to be welded.

Laser welding is an assembly technique that can be advantageously used to interconnect accumulators by welding of the current collector on a pole of each one of the accumulators.

However, the laser welding technique requires that the current collector be pressed in a stable manner against the pole of the accumulator to be welded during the application of the laser beam.

Moreover, wherein the battery is able to be subjected to vibrations during the use thereof, the weld bead must be sufficiently robust to not break under the effect of such vibrations and make it possible to maintain a section of passage that is sufficient for the electric current.

Document CN 206952362 describes a laser welding device comprising a welding mask intended to bear against the current collector, and a laser head to which the welding mask is elastically connected by springs. This elastic connection makes it possible to absorb differences in height between different accumulators, in order to press the current collector and the pole of the accumulator despite a potential variability in the height of the accumulator.

### DISCLOSURE OF THE INVENTION

A purpose of the invention is to design a method and a device for laser welding that makes it possible to form a weld bead of good quality and robust between a first component and a second component. In particular, the device implemented must make it possible to easily ensure, for each weld of a set consisting of the first and the second component, that the focal length of the laser beam is optimal, i.e. suitable for delivering a maximum and controlled energy, i.e. that can be repeated, at the welding area.

To this effect, the invention proposes a method for laser welding a first component to a second component, comprising:
the placing of the first component on the second component,
the application of a welding mask comprising a flat contact surface to the first component in order to press said first component onto the second component, said welding mask comprising a through-passage for a laser beam, defining a welding area on the first component, the contact surface at least partially surrounding said passage,
the emission of a laser beam by a head into said passage of the welding mask, in order to form a weld bead joining the first component to the second component in said welding area.

The welding mask has a rigid structure at least in the direction of the laser beam and is rigidly joined to the laser head. Thus, the dimension of the welding mask in the direction of said beam, that defines the distance between the laser head and the welding area, is constant, even when the mask exerts contact on the welding area. All throughout the welding method, the laser beam therefore has a constant focal length, optimised to deliver the maximum of energy at the welding area, and independent of the contact force applied. In particular, when two sets each consisting of a first component and of a second component are successively welded, the mask provides a constant focal length of the laser beam from one stream to another.

Particularly advantageously, the first and second components and the welding mask remain fixed during the formation of the entire weld bead.

The laser head advantageously comprises a programmable optical focusing system comprising two mirrors that can be oriented for positioning the laser beam at a determined location of the welding area.

The welding mask advantageously has a frustoconical outer shape.

The through-passage can also have a frustoconical wall.

According to an embodiment, the weld bead has a closed shape.

According to an embodiment, the contact surface extends continuously around the welding area. Preferably, said contact surface extends over at least three-quarters of the perimeter of the welding area.

According to an alternative, the contact surface extends discontinuously around the welding area. Preferably, said contact surface is comprised of at least three coplanar contact areas spaced apart from one another.

The laser head can emit a pulsed laser beam or a continuous laser beam.

According to an advantageous application of the invention, the first component is a metal current collector and the second component is a metal-ion electrochemical accumulator.

The invention also relates to a method for assembling a battery comprising a plurality of accumulators, comprising:
the gluing of each accumulator in a flange,
the establishing of an electrical connection between at least two accumulators by a current collector, by laser welding of said current collector onto a respective pole of each accumulator by means of the method described hereinabove.

Particularly advantageously, the position of the head provided with the welding mask is adjusted for each accumulator, in such a way as to offset a difference in height between two accumulators.

Another object of the invention relates to a device allowing for the implementation of said method.

Said device comprises:
a frame comprising a support for the first and second components to be welded,
a laser head movable in vertical translation with respect to the frame,
a welding mask rigidly joined to the laser head in such a way as to ensure a constant focal length of the laser beam, comprising a flat contact surface opposite the laser head, and a through-passage for a laser beam emitted by the head, said passage opening into an opening of the contact surface defining a welding area.

Advantageously, said laser head comprises a programmable optical focusing system comprising two mirrors that can be oriented for positioning the laser beam at a determined location of the welding area.

Preferably, the welding mask has an external frustoconical shape narrowing from the laser head to the contact surface. Moreover, the through-passage advantageously has a frustoconical shape narrowing from the laser head to the welding area.

According to an embodiment, the contact surface extends continuously around the welding area.

Alternatively, the contact surface extends discontinuously around the welding area.

According to an embodiment, the welding mask comprises an electrically insulating coating on at least one portion of the external surface thereof.

Said coating can advantageously comprise a portion made of ceramic extending over the contact surface and over a first portion of the external surface adjacent to said contact surface.

Said coating can also or alternatively comprise a portion made of polymer extending over a second portion of the external surface, opposite the contact surface and adjacent to the first portion.

On the other hand, the inner surface of the welding mask is preferably devoid of such an electrically insulating coating.

### BRIEF DESCRIPTION OF THE FIGURES

Other characteristics and advantages of the invention shall appear in the following detailed description, in reference to the accompanying drawings wherein:

FIG. 1 is a block diagram of the laser welding of a current collector onto an accumulator in the flange thereof;

FIG. 2 is a block diagram of the welding device according to an embodiment of the invention;

FIG. 3 is a perspective view of the positive pole of an accumulator of type 18650;

FIG. 4 shows the contact area of the welding tool and the welding area on an accumulator of the type shown in FIG. 3;

FIGS. 5A and 5B are respectively a side view and a perspective view of a welding tool according to an embodiment of the invention;

FIG. 6 diagrammatically shows the focus of the laser in the welding tool of FIGS. 5A and 5B;

FIG. 7 is a cross-section diagrammatical view of a welding mask comprising two different electrically insulating coatings, with the right side of the figure being an enlargement of the left side at the contact area of the mask on a current collector during the welding thereof onto an accumulator;

FIG. 8 is a cross-section diagrammatical view of the splashes projected into the mask during the welding;

FIG. 9 shows the implementation of the welding of a current collector onto an accumulator with a device according to the invention;

FIG. 10 shows a weld bead carried out on the positive pole of an accumulator of the type shown in FIG. 3.

For reasons of legibility of the figures, all the elements are not necessarily shown to scale.

### DETAILED DESCRIPTION OF EMBODIMENTS OF THE INVENTION

In the following description, interest is given substantially to the case of the welding of a current collector onto a metal-ion electrochemical accumulator, which is a particularly advantageous application of the invention. However, the invention generally applies to the laser welding of a first component onto a second component, said components not necessarily being metal. Those skilled in the art can therefore easily generalise the embodiments that are described hereinbelow by assimilating the metal current collector with the first component and the accumulator with the second component. The shape of said first and second components and that of the welding mask can vary according to the applications considered; however, the two components are welded to one another at a flat surface, which comprises at its centre the welding area in which the weld bead is formed, and in its periphery one or more contact areas for the welding mask.

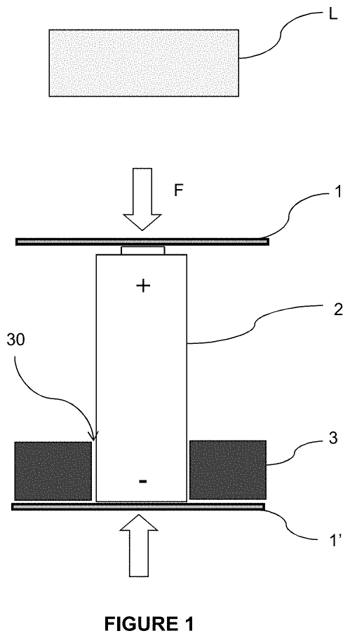

FIG. 1 shows the general principle of laser welding implemented for the assembly of a battery.

The welding device comprises a laser head L, able to emit a pulsed or continuous laser beam, in a substantially vertical direction.

An accumulator 2 was glued beforehand in a housing 30 provided for this purpose in a flange 3. Although this is not shown, the flange includes a plurality of housings each intended to receive an accumulator. The flange is used as a mechanical support for the accumulators and can be made from a plastic, composite or metal material.

The accumulator is housed in the flange in the vertical position, i.e. its positive (+) and negative (−) poles are aligned along a vertical axis. The bottom of the housing is open in order to allow access to the − pole.

The accumulator 2 shown has a cylindrical shape, for example of type 18650, but it goes without saying that this particular shape is given only as an example and that the accumulator could have another shape, in particular prismatic.

The casing of the accumulator can be carried out in different materials, such as aluminium, stainless steel or HILUMIN™ (steel coated with a layer of nickel). The − pole of the accumulator is generally comprised of a flat bottom, while the + pole has a head in relief with a smaller diameter than the − pole.

To electrically connect the accumulator 2 to another accumulator (not shown), a current collector 1, 1′ must be welded to each of the two poles, the weld bead providing not only a mechanical connection between the two components but also an electrical connection. The weld bead advantageously has the longest length possible. Moreover, the weld bead advantageously has a closed shape, which increases the robustness of the assembly. Other weld bead forms are also possible according to the target application, for example a bead in the shape of a helix, in the shape of a cross, etc.

The current collector is formed by stamping and/or cutting a metal sheet according to a shape adapted to the design of the battery. The thickness of the current collector is generally comprised between 0.1 and 1 mm. The material of the current collector can be aluminium, stainless steel, steel or copper. These materials can possibly have received a surface treatment such as nickel-plating, tin-plating. Naturally, materials will be chosen that are compatible in terms of welding for the accumulator and the current collector.

According to the materials to be welded, welding can be carried out by transparency or by thermal conduction.

To this effect, the current collector 1 must be pressed against the + pole of the accumulator 2 with a force F during the application of the laser beam in order to form the weld bead.

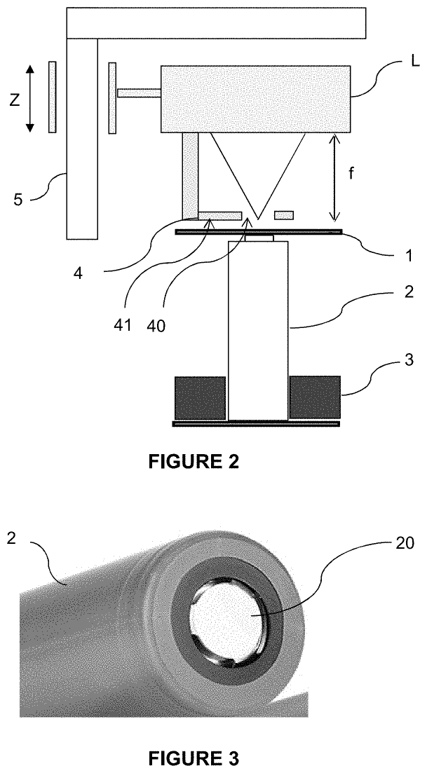

FIG. 2 is a block diagram of a welding device that allows for the application of such a force during the formation of the weld bead.

This device implements a welding mask 4 that comprises a through-passage that opens, on the side opposite the laser head, onto an opening 40 that defines a welding area. The mask further comprises a contact surface 41 surrounding at least partially the opening 40, so as to ensure the pressing of the current collector 1 on the accumulator 2.

The welding mask has great rigidity at least along the direction of the laser beam. This means that the mask cannot be deformed during the application of normal mechanical stresses during the implementation of the method.

To ensure a fixed focal length f, the welding mask 4 is rigidly joined to the laser head L.

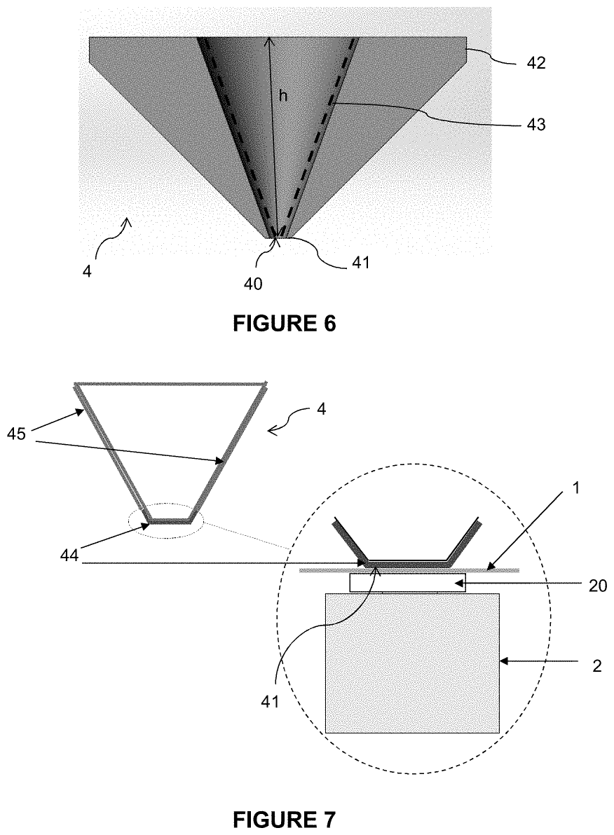

Said focal length is chosen in such a way as to deliver a maximum and controlled energy at the welding area. When it is the dimension (also referred to as “height”, noted as h in FIG. 6) of the mask in the direction of the laser beam that defines the distance between the laser head and the welding area, said focal length is defined according to said dimension of the mask in the direction of the laser beam and is independent of the contact force applied. Once this optimum focal length is adjusted in an initial step, it is maintained constant throughout the entire duration of the welding method of the accumulator or accumulators, with the distance between the laser head and the welding area not varying. Any differences in height from one accumulator to another are absorbed by the pressing of the mask against the current collector.

In order to make it possible to adjust the position of the mask with respect to the components to be welded and to control the contact force of the mask, the laser head L is mobile in translation in a vertical direction (diagrammed by the double area Z) with respect to a frame 5, for example by means of a cylinder or a spring. This system does not require fine management of the contact force, as the focal length of the laser is directly linked to the fixed height of the welding mask. Said frame further comprises a support (not shown) for the components to be welded.

Thus, regardless of the dimensional variations of the accumulators or the positioning clearances of the accumulators in the flange, the mask can still be placed in contact against the current collector and the required force applied in order to ensure good pressing during the formation of the weld bead and guarantee the focal length of the laser.

On the contrary, in the device described in the aforementioned document CN 206952362, the elastic connection between the mask and the laser head does not make it possible to guarantee an optimum focal length regardless of the height of the accumulators. The precision of the focal length is indeed limited by the precision of the displacement of the head with respect to the mask, in line with the contact force applied. Consequently, the mechanical resistance of the welding area can vary from one accumulator to another.

A particularly delicate case is the welding of the current collector onto the + pole of the accumulator because, as can be seen in FIG. 3, the contact surface available for the formation of the weld bead is particular reduced. Thus, in the case of an accumulator of type 18650, the diameter of the area 20 available is about 9 mm.

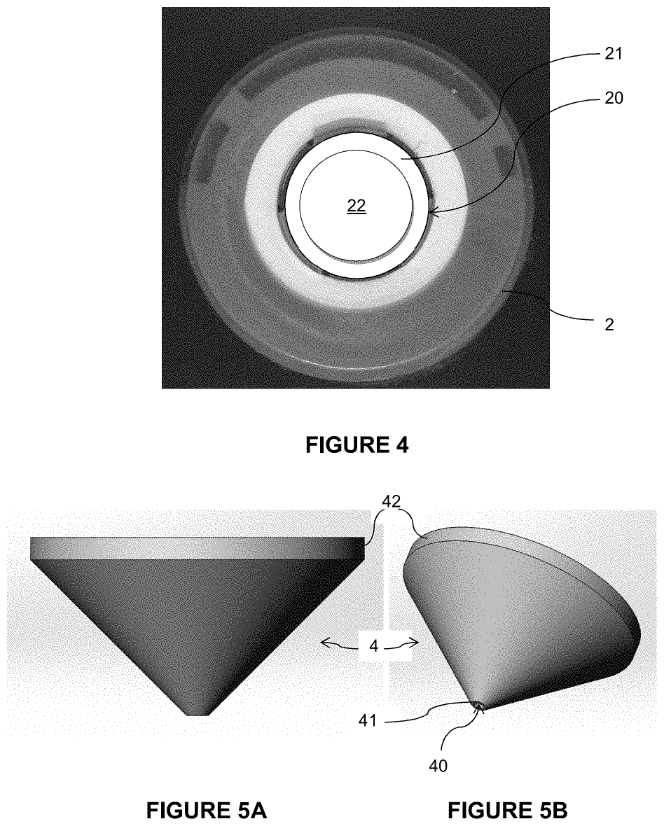

In reference to FIG. 4, said available area 20 is used to form a peripheral contact area 21, intended to receive the contact surface of the mask, and an area 22 of central welding, in which the weld bead can be formed. To optimise the available surface, the contact area 21 is of annular shape and extends from the outer edge of the available area 20, but it goes without saying that according to the configuration of the available area it is possible to choose any shape for the contact area and the welding area.

For the welding, the mask thus bears against the current collector (not shown in FIG. 4) to press it against the contact area 21 of the + pole of the accumulator.

According to an embodiment, the contact surface of the mask is continuous, i.e. of a single piece. Said surface must be sufficiently large with respect to the perimeter of the welding area to ensure a good pressing of the two components in the welding area. It is thus considered that the contact surface must extend over at least three-quarters of the perimeter of the welding area. Thus, in the case where the welding area is circular, the contact surface advantageously extends over an angular sector comprised between 270 and 360°.

According to a particular embodiment, the contact surface entirely surrounds the welding area.

According to another embodiment, the contact surface is discontinuous, i.e. it comprises a plurality of coplanar contact regions that are separated by hollows. Preferably, said regions have a sufficient surface and are distributed sufficiently regularly to provide a correct pressing of the two components to be welded. For example, the contact surface can be formed from three coplanar regions in an arc of circle separated by the same distance. Such a discontinuous contact surface has the advantage of allowing for the removal of fumes generated during the welding, and thus reduce the clogging of the mask. These releases can also make it possible to reduce the risks of unintentional contacts according to the geometry of the batteries to be welded (e.g. foils waiting for welding, or partially welded), or a simple configuration for adding via the blowing of specific gases (ex. blanketing gas).

FIGS. 5A and 5B show an outer view of the side and in perspective of a welding mask that is particularly suited for the welding of a current collector onto the pole of the accumulator of FIGS. 3 and 4, but which is also advantageous for other configurations.

Said mask 4 has an external frustoconical shape, narrowing from the laser head to the welding area. The contact surface 41 is located in a plane that forms the end of the mask opposite the laser head. In the example shown, the contact surface has a continuous annular shape, but as indicated hereinabove, said contact surface could extend only over an angular sector or over several angular sectors that are separated from one another.

An advantage of such a frustoconical shape is that the space requirement of the mask on the side of the components to be welded is minimised.

Optionally, the end 42 of the mask located on the side of the laser head can have a cylindrical portion, for example for the fastening of the mask to the laser head.

The fastening of the welding mask to the laser head can be carried out by any suitable means.

The mask is made from a material that is opaque to the laser beam, for example a metal material that resists heat and the laser beam in case of a programming error. Such a material can be stainless steel, steel coated with a protective layer suitable for preventing corrosion and of which the pollution of the components to be welded, aluminium that is advantageously black anodised in order to absorb light well, etc.

As can be seen in FIG. 6, the mask comprises a through-passage 43 for the passage of the laser beam (diagrammed as a dotted line). Advantageously, said passage 43 also has a frustoconical shape, which makes it possible to adapt to the geometry of the beam.

The through-passage 43 opens onto an opening 40 advantageously located at the centre of the contact surface 41 and thus defines a welding area on the components to be welded.

According to an advantageous embodiment, the welding mask comprises an electrically insulating coating, in such a way as to minimise the risks of short-circuit between the different parts of the battery during the welding. In a conventional assembly method, these risks are taken into account by placing electrically insulating barriers between the accumulators, which increases the cost and the weight of the battery. The electrically insulating coating makes it possible to overcome these protective devices.

Said coating is applied on the contact surface and over at least one portion of the outer surface of the mask.

Said coating can comprise different materials according to the region of the mask. Thus, in reference to FIG. 7, the contact surface and the outer surface adjacent to said contact surface are subjected to substantial mechanical and thermal stresses due to the contact force and the high temperature implemented during the welding. In this portion of the mask, the coating must advantageously be able to resist temperatures of about 1085° C. (melting temperature of copper, which is the most thermally critical material to be welded during the assembly of a battery). Moreover, the material of the coating must be able to be deposited in the form of a thin (typically, of about ten micrometres) and uniform layer so as not to degrade the focusing of the laser beam. For example, a ceramic (such as alumina) can be deposited on this portion of the mask. This ceramic can withstand a peak temperature of 1650° C.; in addition, it has very good resistance to wear (hardness greater than 800 HV) and a rather good resistance to friction, while still remaining chemically inert. The thickness deposited can be comprised between 5 μm and 20 μm, which is compatible with the tolerance on the focal length that can be accepted by the equipment (said tolerance being about ±1.5 mm). The deposition of ceramic can be carried out by physical vapour deposition (PVD) or by chemical vapour deposition (CVD). Optionally, a running-in can be implemented in order to improve the flatness and the uniformity of the thickness of the coating at the contact surface.

According to the material and the thickness thereof, a step of running-in or flattening of the coating can be carried out at the contact surface so as to guarantee both surface flatness and good dimensional control of the final height of the mask, in line with the desired focal length.

Over a portion of the outer surface that is farther away from the contact surface, the mechanical and thermal stresses are less substantial. On the other hand, this portion is able to come into contact with elements of the battery during assembly or with the welding system. A polymer material, such as poly(vinylidene fluoride) (PVDF) or Polytetrafluoroethylene (PTFE), able to absorb impacts without being damaged, can be used.

In the embodiment shown in FIG. 7, the electrically insulating coating comprises a first portion 44 made of ceramic extending over the contact surface and a first portion of the outer surface adjacent to the contact surface, and a second portion 45 made of polymer extending over a second portion of the external surface adjacent to the first portion, to the end of the mask opposite the contact surface.

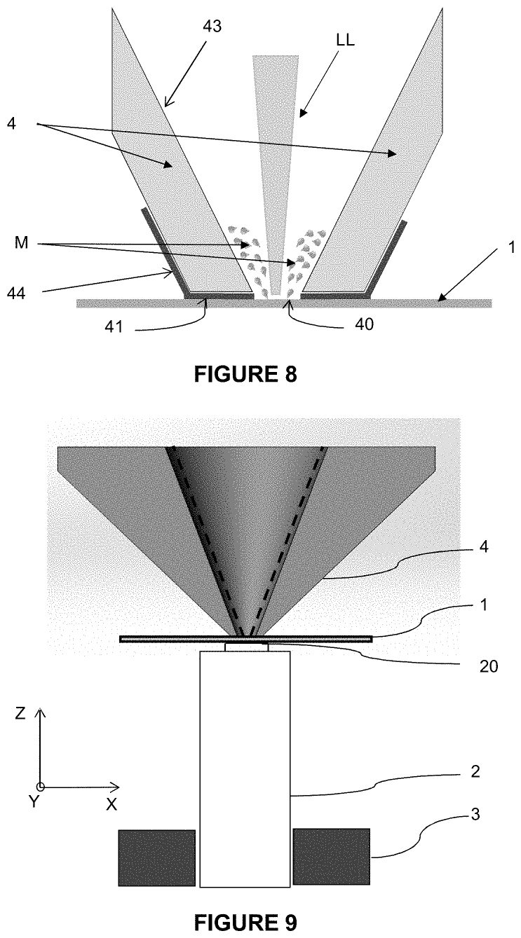

Preferably, as shown in FIG. 8, no coating is applied on the inner surface of the mask 4 defining the through-passage 43, in order to prevent a streaming of the material M projected into the mask during the welding (the laser beam is designated by the mark LL), which would fall onto the welding area and pollute it. By leaving exposed the metal inner surface of the mask, the projected material tends to be fixed on said surface. The mask can be cleaned periodically, for example by machining, in such a way as to remove the accumulated depositions of material.

In order to carry out a weld bead in the welding area without moving the components to be welded, the laser head is provided with a programmable optical focusing system that makes it possible to selective orient the laser beam within the welding area. Such an optical system typically comprises two mirrors that can be oriented precisely and rapidly. In the case of a pulsed laser, the weld bead is formed from a plurality of welding spots each corresponding to a successive focusing position. In the case of a continuous laser, the weld bead is formed from a line, a succession of segments or a continuous curve of which the path is defined by the movement of the beam.

Thanks to the flat-field objective, the focusing conditions, and therefore the quality of the weld bead, are identical at each spot of the welding area.

FIG. 9 shows the welding mask 4 in contact with the current collector 1 for the purpose of the welding thereof onto the + pole of the accumulator.

The contact surface of the mask is centred with respect to the available area 20 of the + pole of the accumulator and therefore procures a stable pressing of the current collector on said pole. The welding area is therefore also centred in relation to said pole. A weld bead can therefore be formed in said zone.

In light of the geometry of the welding area, the weld bead advantageously has a circular form. Of course, for other applications, the weld bead could have another form.

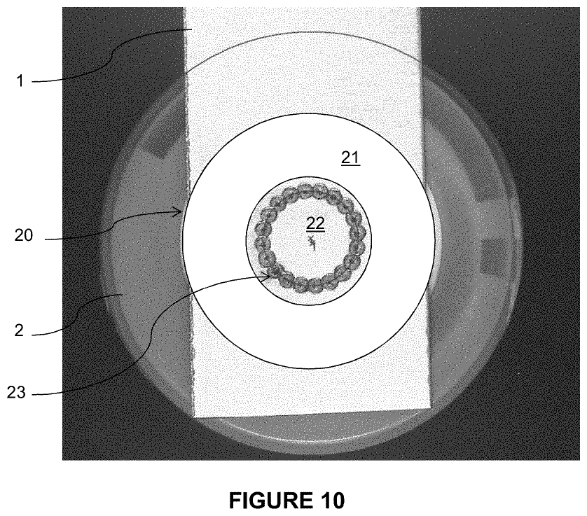

As shown in FIG. 10, the weld bead 23 is constituted of 20 spots that overlap slightly, centred on a circle 4 mm in diameter. In light of the size of the welding spots (diameter of 0.6 mm), the outer diameter of the weld bead is about 4.6 mm. This diameter is chosen to be strictly less than the inside diameter of the opening formed in the welding mask (which is in this example 5.2 mm) so as to not risk welding the mask to the current collector, while still taking account of any dimensional variations that could induce offsets in position with respect to a nominal position.

The outer diameter of the contact area 21 of the mask is 8 mm; the width of the annular contact surface is therefore 1.4 mm, which is, in the example considered, sufficient to ensure good pressing of the two components together.

The laser head and the support carrying the components to be welded are movable in relation to one another in the three directions of space, so as to allow for a successive welding of several accumulators. According to an embodiment, the laser head and the support can be movable along different axes. Alternatively, the support can be fixed and the laser head mobile in order to bring the mask facing each accumulator to be welded.

For example, in reference to FIG. 9, once the current collector has been welded onto an accumulator, the mask and the laser head are raised (according to the axis Z) in a position that is sufficiently high to not interfere with the components to be welded. The support carrying the flange and/or the head provided with the mask are displaced in the plane X, Y in order to bring the mask facing the pole of another accumulator to be welded to the current collector. Then, the head and the welding mask are again lowered in order to place the welding mask in contact against the current collector. A new weld bead can then be formed as described hereinabove.

Thus, the assembly of the battery is not affected by any differences in the height of from one accumulator to another, and all of the weld beads can be carried out in a repeatable manner.

As indicated hereinabove, the present invention is not limited to the welding of a current collector onto an accumulator. In the field of assembling batteries, the invention can also be applied to weld two current collectors. For example, a current collector can be comprised of a copper foil 500 μm thick and another current collector, welded onto the latter, is comprised of a HILUMIN™ foil 300 μm thick. No special tools are required for the welding. A plurality of circular weld beads can be formed successively by pressing the two foils in the respective welding area by means of the mask described hereinabove.

In the case of laser welding plastic components, the welding is carried out by transparency: the components to be welded, which are comprised of two different materials, one transparent to laser radiation and the other absorbent, are superimposed. The laser beam, focused at the junction of the two components, passes through the transparent material and causes the absorbent material to melt. The welding of plastics is then carried out by the solid connection resulting from the rapid cooling of the assembly after the passing of the laser beam. The laser technology is different from that used for metal welding as it requires the use of a laser with a wavelength that is adapted to the colour of the components to be welded.

1. A method for laser welding a first component to a second component, comprising:
placing the first component on the second component,
applying a welding mask comprising a flat contact surface to the first component to press said first component onto the second component, said welding mask comprising a through-passage for a laser beam, defining a welding area on the first component, the contact surface at least partially surrounding said through-passage,
emitting a laser beam by a head into said through-passage of the welding mask, in order to form a weld bead joining the first component to the second component in said welding area,
wherein the welding mask is rigid and rigidly joined to the laser head and a focal length of the laser is constant, said constant focal length being ensured by said rigid welding mask

2. A method according to claim 1, wherein the first and second components and the welding mask remain fixed during the formation of the entire weld bead.

3. A method according to claim 1, wherein the laser head comprises a programmable optical focusing system comprising two mirrors that can be oriented for positioning the laser beam at a determined location of the welding area.

4. A method according to claim 1, wherein the welding mask has an external frustoconical shape.

5. A method according to claim 1, wherein the through-passage has a frustoconical wall.

6. A method according to claim 1, wherein the weld bead has a closed shape.

7. A method according to claim 1, wherein the contact surface extends continuously around the welding area.

8. A method according to claim 7, wherein the contact surface extends over at least three-quarters of a perimeter of the welding area.

9. A method according to claim 1, wherein the contact surface extends discontinuously around the welding area.

10. A method according to claim 9, wherein the contact surface is comprised of at least three coplanar contact areas spaced apart from one another.

11. A method according to claim 1, wherein the head emits a pulsed laser beam.

12. A method according to claim 1, wherein the head emits a continuous laser beam.

13. A method according to claim 1, wherein the first component is a metal current collector and the second component is a metal-ion electrochemical accumulator.

14. A method for assembling a battery comprising a plurality of accumulators, comprising:
the gluing of each accumulator in a flange,
the establishing of an electrical connection between at least two accumulators by a current collector, by laser welding of said current collector onto a respective pole of each accumulator by means of the method of claim 13.

15. A method according to claim 14, wherein a position of the head provided with the welding mask is adjusted for each accumulator, in such a way as to offset a difference in height between two accumulators.

16. A device for laser welding a first component onto a second component, comprising:
a frame comprising a support for the first and second components to be welded,
a laser head movable in vertical translation with respect to the frame,
a welding mask that is rigid and rigidly joined to the laser head in such a way as to ensure a constant focal length of the laser beam, comprising a flat contact surface opposite the laser head, and a through-passage for a laser beam emitted by the head, said through-passage opening into an opening of the contact surface defining a welding area.

17. A device according to claim 16, wherein the laser head comprises a programmable optical focusing system comprising two mirrors that can be oriented for positioning the laser beam at a determined location of the welding area.

18. A device according to claim 16, wherein the welding mask has an external frustoconical shape narrowing from the laser head to the contact surface.

19. A device according to claim 16, wherein the through-passage has a frustoconical shape narrowing from the laser head to the welding area.

20. A device according to claim 16, wherein the contact surface extends continuously around the welding area.

21. A device according to claim 16, wherein the contact surface extends discontinuously around the welding area.

22. A device according to claim 16, wherein the welding mask comprises an electrically insulating coating on at least one portion of the external surface thereof.

23. A device according to claim 22, wherein said coating comprises a portion made of ceramic extending over the contact surface and over a first portion of the external surface adjacent to said contact surface.

24. A device according to claim 22, wherein said coating comprises a portion made of polymer extending over a second portion of the external surface, opposite the contact surface and adjacent to the first portion.

25. A device according to claim 22, wherein the welding mask has an inner surface devoid of said electrically insulating coating.
